(19) United States
(12) Patent Application Publication
(10) Pub. No.: US 2023/0043945 A1
(43) Pub. Date: Feb. 9, 2023

(54) METHOD FOR MAKING A CASE FOR A MOBILE DEVICE WITH A SCREEN

(71) Applicant: TECH 21 LICENSING LIMITED, Surrey (GB)

(72) Inventors: Haim GEVA, Surrey (GB); James GARDNER, Surrey (GB)

(21) Appl. No.: 17/792,609

(22) PCT Filed: Jan. 13, 2021
(86) PCT No.: PCT/GB2021/050067

§ 371 Date: Jul. 13, 2022

(30) Foreign Application Priority Data
Jan. 13, 2020 (GB) 2000468.5

(51) Int. Cl. A45C 11/00; B33Y 80/00; B29C 53/04; H04M 1/18

(52) U.S. Cl. CPC A45C 11/00; B33Y 80/00; B29C 53/04; H04M 1/185; A45C 2011/003; A45C 2011/002; B29L 2031/7162

(57) ABSTRACT

A method of making a case for a mobile device with a screen. The method comprising 3D printing of the case in a partially finished form on a support surface in a configuration in which rear wall (1) and sidewalls (2-5) lie alongside one another on the surface, and folding the sidewalls up relative to the rear wall to at least partially create a cavity for the device. Separate corner portions (10, 11) may be provided to connect the sidewalls. The invention also extends to a 3D printed blank from which the case is formed.

The present invention relates to a method of making a case for a mobile device with a screen. Such devices include smartphones, tablets, e-readers and the like.

Such cases are traditionally moulded in plastic.

This has a number of benefits in that the cases can be made very quickly. However, there are a number of drawbacks. Each new case requires a bespoke mould to be made which results in expensive tooling costs. The moulds are relatively intensive in manpower which again adds to the cost of manufacture. The process is also relatively energy intensive in that the moulding process requires a significant amount of metal to be heated and a relatively large quantity of plastic to be melted. The facilities which produce such cases are large scale plants as the machinery required has a high capital expense. As a result of this, in order to manufacture cases currently it is often the case that the raw materials are produced in the US and Europe before being shipped to China for moulding and then being supplied across the world. This long transport chain is undesirable for environmental and cost reasons.

3D printing can solve some of these problems in that no mould is required such that the new designs can generally be produced by the programming of the printer. Further, the energy costs are significantly reduced as only the plastic actually required for the case needs to be heated up. The 3D printing also does not require the same level of supervision as the moulding operation.

However, there are significant drawbacks in a 3D printing process. Whilst a typical moulding process can produce a case in around one minute, 3D printing will typically require 45 minutes to produce a case.

A case would typically be printed with the rear wall being printed on a flat support surface first, whereupon the sidewalls are progressively build up around the periphery of the rear wall. This takes a relatively long time given that the depth of the walls has to be built up a layer at a time. Further, the sidewalls are generally required to have a number of relatively large orifices to accommodate various buttons, ports and speakers in the device. These can only be produced in 3D printing if a support is provided in the location of these orifices so that the upper edge of the orifice can be formed on the support.

3D printing processes are capable of producing a high quality surface finish on the rear face of the case which is in contact with a support surface during the printing process. However, the sidewalls of the case are built up in an unsupported area such that the same high quality surface cannot be produced on the sidewalls.

The present invention addresses some of the problems.

According to the present invention, there is provided a method according to claim 1.

3D printing the case in an orientation in which the rear and sidewalls are alongside one another and subsequently folding the sidewalls up, solves a number of the above mentioned problems in relation to 3D printing of a case for a mobile device.

The sidewalls can now be printed at the same time that the rear wall is printed rather than having to wait until the rear wall is printed before building up periphery of the rear wall to print the sidewalls. The maximum depth which now needs to be printed corresponds to the maximum thickness of the sidewalls or rear wall, whereas previously the maximum depth to be printed corresponded to the maximum depth of the case. This significantly reduces the number of layers which needs to be printed thereby significantly reducing the time for the printing process. We estimate that 3D printing the case in this way will take approximately half the time that it would take to 3D print the whole case with upstanding sidewalls.

Further, because the sidewalls are printed on the support surface, the outer face of the sidewalls has the same high quality surface finish as the rear wall.

The other exposed faces of the case are generally the faces which face into the cavity in which the device is held such that they are not visible in use and do not therefore require a high quality surface finish. Because the sidewalls are printed on a support surface, orifices can easily be formed in the sidewalls simply by not printing the plastic in the area occupied by the port thereby avoiding the need for providing support while the sidewall is build up around an orifice.

Taking all of these matters into consideration, the present invention allows a case to be successfully produced using a 3D printing technique. This takes advantage of the benefits of a 3D printing technique in that in particular, it is easy to set up 3D printing facilities in a vicinity of the local market for the case and/or in the vicinity of the facility which produces the raw materials. The energy requirement is also much lower. This greatly reduces the carbon footprint of each case. Further, it allows the design of the case to be changed without requiring a new mould to be created thereby allowing a greater range of cases to be produced with much greater flexibility and significantly reduced cost.

The case may be fully assembled at a single location. However, one possibility is to having 3D printed the case in the partially finished form, it can be transmitted in that form. Because such a form is substantially flat, the cases can be stacked in a much more efficient manner than a fully assembled case allowing more economic transport. The case may be sold in this form with the corner potion being sold together with the partially finished case. Alternatively it may be sold separately to allow for a degree of customisation by the consumer. Alternatively the case may be assembled at or close to the retail site to take advantage of the more economic packaging as far as possible.

The thickness and material of the rear wall and side walls may be such that the side walls can be folded up without requiring any additional features. However, preferably, the method further comprises 3D printing, a living hinge at interface between the rear wall and an adjacent side wall. This allows a better defined fold to be produced and allow greater flexibility in the material used for the case.

The method preferably comprises the step of joining adjacent sidewalls to one another via corner portions.

The corner portions may be 3D printed integrally with the sidewalls. In one arrangement, each end of sidewalls is formed with an upwardly curving configuration which extends away from the support surface. When the sidewalls are folded up, these curved portions can form all or part of the corner portions of the case. However, preferably, the corner portions are separate components which connect to adjacent sidewalls. The corner portions may be moulded. However, they are preferably 3D printed to create a fully 3D printed case.

The corner portions may be attached using an adhesive but are preferably snap fitted into place.

Each corner portion may be a single piece. However, preferably, each corner portion comprises an inner segment and an outer segment, the inner segment is preferably made of a material which is softer than the outer segment. The two segments can be pushed together, in situ, to engage with the adjacent side walls thereby locking the case in its assembled configuration.

The support surface may be made in any suitable material that but preferably a glass surface, and more preferably a heated glass surface.

The support surface may be entirely flat. However, preferably, the support surface has recessed or protruding features which form a pattern or texture on the outer face of the side walls and/or the rear wall.

The present invention also extends to a blank from which the case can formed as well as the finished case formed from the blank.

An example of a method of making a case for a mobile device with a screen will now be described with reference to the accompanying drawings:

FIG. 1 is a plan view of a case on a support prior to full assembly in the form in which it is 3D printed;

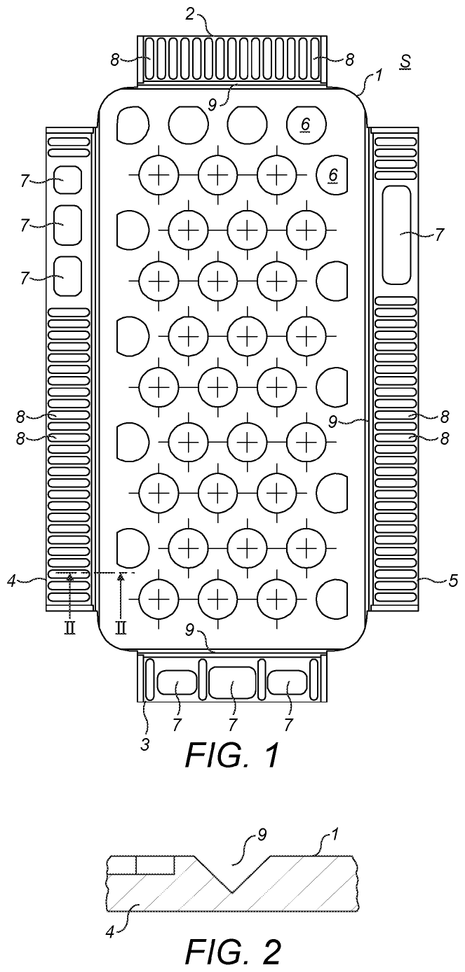

FIG. 2 is a cross section through line II in FIG. 1

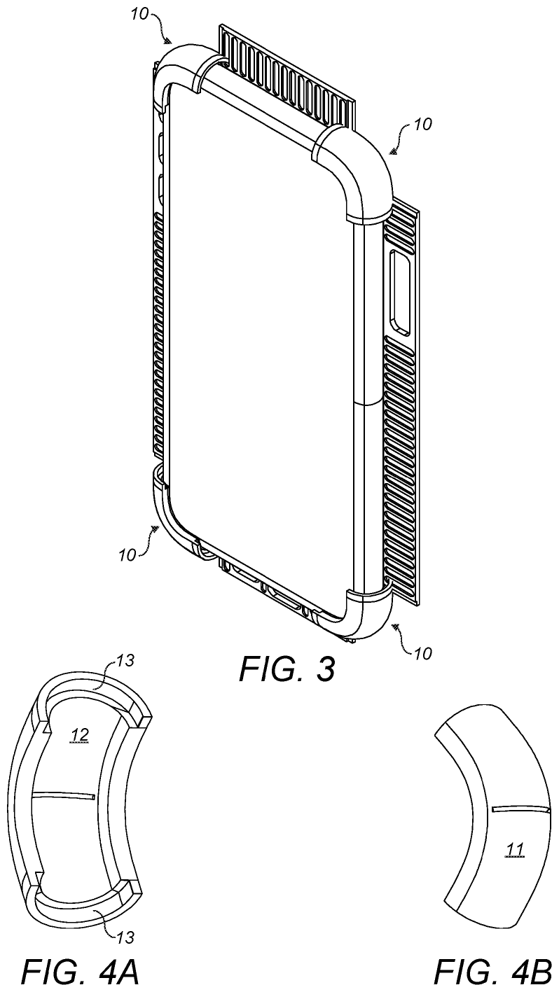

FIG. 3 is a perspective view showing the partially assembled case.

FIG. 4A is a perspective view of an outer corner segment; and

FIG. 4B is a perspective view of an inner corner segment in the opposite direction to the view of FIG. 4A.

The part formed case is formed by 3D printing in the form shown in FIG. 1 onto a flat surface S which is a heated glass surface. Any suitable 3D printing technique may be employed. However, preferably, the 3D printing is fused deposition modelling (FDM), selective laser sintering (SLS) or stereolithography (SLA).

The case comprises a rear wall 1 with a top side wall 2, bottom side wall 3 and lateral side walls 4, 5. As shown in FIG. 1, sidewalls 2-5 are printed in a configuration in which are supported by the surface S. This could be an entirely planar surface, or may be provided with features such as ridges and recesses which provide surface detail on the outer faces of the walls 1-5.

Conveniently, the sidewalls 2-5 are printed to be co-planar with the rear wall 1. However, the surface S could be inclined to a small extent in these regions such that the rear walls are produced in a plane which is angled with respect to the plane of the rear wall.

The 3D printing process occurs by gradually building up layers of plastic by printing these into the surface S. As will be appreciated from the consideration of FIG. 1, the maximum depth to be printed would be the maximum thickness of the thickest wall 1-5.

The printed material is precisely deposited by the printer in order to form external features on the walls of the devices such as buttons not shown in FIG. 1 as these are formed on the rear face of the case.

The 3D printing process also allows for the formation of infill patterns in the form of recesses 6 in the inner face of the rear wall 1. These reduce the mass and material cost of the case as well as producing impact protection features in the form of localised air cushions in the vicinity of a recess 6.

This method is particularly suited for forming orifices 7 in the sidewalls where this is done by simply not printing in these areas. Also, features on the internal faces on the sidewalls 2-5 such as ribs 8 can also be easily produced by 3D printing.

It is useful to form the ribs 8 in a softer material than the remainder of the case in order to provide enhanced impact absorption. With the above described method, the rear wall and the bulk of the side walls 2, 4, 5 can be printed from a first material while a second material can then be used to print the ribs 8. If the walls were printed directly in an upstanding configuration, numerous changes of material would be required as both materials would be repeatedly used in the same layers.

The interfaces between the rear wall 1 and the sidewalls 2-5 have living hinge 9 (best shown in FIG. 2) about which each of the sidewalls can be folded up to formed a cavity.

Adjacent sidewalls are connected by corner components 10 shown in FIGS. 3, 4A and 4B. These can moulded or 3D printed.

As shown in FIGS. 4A and 4B, the corner component 10 comprises an inner segment 11 an outer segment 12. The corner component could, instead, be made of a single piece. The inner segment 11 is generally formed of a softer cushioning material, for example, FlexShock®. This may be provided with inwardly projecting ribs (not shown) to enhance the cushioning effect. The outer segment 12 is made of a harder material such as TPU which is provided with locking ridges 13 at either end in order to snap fit onto the corners of the case to hold the side walls of the case together to maintain the case in its assembled configuration.

The inner segments 11 are fitted in place on the four corners of the printed component. The side walls 2-5 are then folded up along with the living hinges 9 and the outer segments 12 are then snapped into place in order to retain the finished case in place. FIG. 3 shows the positional relationship of the outer segments 12 in relation to the unfolded case. In practice, however, the side walls 2-5 are folded up before these are put into place.

As an alternative to or in addition to the snap fit connection of the corner components 10 an adhesive may be used to hold these in place.

Cases are generally required to provide the best impact resistance in the corner regions. Thus, the use of separate corner portions 10 can be advantageous as it allows different materials or structures to be used in these corner regions. Although the corner portions have a greater depth than the main 3D printed portion shown in FIG. 1, they can be produced relatively quickly because they are much smaller components such that the layers can be built up more quickly.

1. A method of making a case for a mobile device with a screen, the case having a rear wall and a plurality of upstanding sidewalls forming a cavity for the device, in use;
the method comprising:
3D printing of the case in a partially finished form on a support surface in a configuration in which the rear wall and sidewalls lie alongside one another on the surface; and
folding the sidewalls up relative to the rear wall to at least partially create the cavity.

2. A method according to claim 1, further comprising 3D printing a living hinge at an interface between the rear wall and an adjacent side wall.

3. A method according to claim 1, further comprising the step of joining adjacent sidewalls to one another via corner portions.

4. A method according to claim 3, wherein the corner portions are separate components which connect to adjacent sidewalls.

5. A method according to claim 4, wherein the corner portions are 3D printed.

6. method according to claim 4, wherein the corner portions are snap fitted into place.

7. A method according to claim 4, wherein each corner portion comprises an inner segment and an outer segment.

8. A method according to claim 7, wherein the inner segment is made of a material which is softer than the other segment,

9. A method according to claim 1, wherein the support surface is glass.

10. A method according to claim 1, wherein the support surface is heated.

11. A method according to claim 1, wherein the support surface has recessed or protruding features which form a pattern or texture on the outer face of the side walls and/or the rear wall.

12. A blank of material foldable to form a case for a mobile device, the blank comprising a rear wall for the device and a plurality of sidewalls extending in substantially the same plane as the rear wall, a hinge being provided between the rear wall and each respective sidewall about which the sidewalls can be pivoted into a finished configuration in which they extend transversely to the rear wall to define a cavity to receive, in use, a mobile device.

13. A case for a mobile device with a screen, comprising a blank according to claim 12 in the configuration in which sidewalls extend transversely to the rear wall, adjacent sidewalls being joined by a corner portion to support the sidewall in the upstanding configuration.
